(19) United States
(12) Patent Application Publication
(10) Pub. No.: US 2006/0066523 A1
(43) Pub. Date: Mar. 30, 2006

(54) Display device and display method

(75) Inventors: Takayuki Arai, Hiratsuka-shi (JP); Tsutomu Sakamoto, Fukaya-shi (JP); Toshio Obayashi, Hiratsuka-shi (JP); Masao Yanamoto, Ichihara-shi (JP); Yasuhiro Ookawara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/170,317

(22) Filed: Jun. 30, 2005

(30) Foreign Application Priority Data
Sep. 30, 2004 (JP) P2004-289405

(51) Int. Cl. G09G 3/22

(52) U.S. Cl. 345/75.2

(57) ABSTRACT

A display device 1 includes: a display panel 10 in which display pixels Px driven by a drive signal having plural stages of amplitudes and pulse widths are disposed; an output data conversion circuit for an X driver 46 converting an image signal inputted from an inverse γ correction circuit 42 side into a signal having an amplitude component corresponding to an amplitude and a pulse width component corresponding to a pulse width of a signal line drive signal; and a drive signal generation portion 23 generating the signal line drive signal from the image signal converted by the output data conversion circuit for the X driver 46. The output data conversion circuit for the X driver 46 refers to a look up table for an output conversion of the X driver, and converts the image signal so as to correct a nonlinearity during a rising period of the signal line drive signal.

### CROSS-REFERENCE TO THE INVENTION

This application is based upon and claims the benefit of priority from the prior Japanese Patent Application No. 2004-289405, filed on Sep. 30, 2004; the entire contents of which are incorporated herein by reference.

### BACKGROUND

1. Field of the Invention

The present invention relates to a display device such as a field emission display, and a display method.

2. Description of the Related Invention

A matrix drive type display device, called a field emission display (FED) in which an electron emission element and a phosphor are disposed between two substrates and the phosphor is light emitted by electrons emitted from the electron emission element to perform a display, has been developed. In this display device, a method combining a pulse width modulation system modulating a pulse width of a voltage supplied to a display portion and an amplitude modulation drive system modulating an amplitude of the voltage in accordance with a strength of an image signal and so on, is adopted to increase gradation of the image signal.

When the above stated systems are adopted, a light-emitting brightness proportionally increases in accordance with an increase of a drive current, and a relation between an input and the light-emitting brightness has approximately a linear characteristic. However, the image signal has a γ characteristic because it is generally assumed to be displayed on a cathode-ray tube. Consequently, it is required to perform what is called an inverse γ correction to the inputted image signal when the image signal having the γ characteristic is applied to the display device having the linear characteristic (for example, refer to Japanese Laid-open Application No. 2004-61862).

However, there is a case when an image cannot be truly reproduced because the above-stated linear brightness characteristic cannot be obtained even though such inverse γ correction is performed. Namely, at a rising time of a drive pulse outputted from a signal line driver, some time is required until a waveform rises completely due to an influence of an inductance component, and so on, of wiring of a display panel. In particular, in a display panel of a large screen, the wiring becomes long, and therefore, the influence becomes large. Herewith, when an output value is small, there is a case when the drive pulse does not rise completely, and a brightness thereof may be lower than a logical value. Besides, the phosphor becomes saturated as the pulse width becomes large, and the deterioration of the brightness may also be provoked in this case.

Further, such characteristic has some dispersion by every display panel. Besides, a low brightness region of a display device (a region with a small output value) is an important element for a display performance thereof. Namely, the brightness is low, and therefore, a rate of an error component relative to the brightness becomes large, and the error becomes remarkable. Herewith, it is necessary to perform a correction by every display panel so that the output value and the brightness are to have a linear characteristic. Here, when this correction is performed, it is conceivable to add a new correction circuit, to use different look up tables for inverse γ correction by every panel, and so on. However, in the former case, an increase of a cost may be provoked by an addition of the new correction circuit. Besides, the latter look up tables for inverse γ correction are required to be switched such as 2.2 power, 2.4 power, and so on, by various image modes, and according to this, the look up tables for various inverse γ correction are required by every display panel, and a problem remains in terms of the cost as same as the above-stated case.

The present invention is made to solve these problems, and the object thereof is to provide a display device and a display method capable of obtaining a good gradation characteristic by realizing an effective gradation correction while suppressing the increase of a manufacturing cost.

### SUMMARY

To achieve the above stated object, a display device according to one aspect of the present invention, including: a display unit in which pixels driven by a drive signal having plural levels of amplitudes and pulse widths are disposed; an input unit inputting an image signal containing information representing gradations corresponding to a brightness of the pixel; an output data converter for a signal line driver converting an input signal inputted to the input unit into a signal having an amplitude component corresponding to the amplitude and a pulse width component corresponding to the pulse width based on the gradations; and a drive signal generator generating the drive signal from the output signal of the output data converter for the signal line driver. In the display device of the present invention, a gradation correction to realize a linear characteristic may be performed at the output data converter for the signal line driver (X driver).

### BRIEF DESCRIPTION OF THE DRAWINGS

FIG. 1 is a block diagram functionally showing a display device according to one embodiment of the present invention.

FIG. 2 is a view for explaining a function of an output data conversion circuit for an X driver included by the display device in FIG. 1.

FIG. 3 is a graph representing an example of a signal waveform of a signal line drive signal.

FIG. 4 is a waveform chart showing a signal line drive signal (and a scanning signal) generated based on an image signal to which a correction by the output data conversion circuit for the X driver in FIG. 2 is not applied.

FIG. 5 is a waveform chart showing the signal line drive signal generated based on the image signal to which the correction by the output data conversion circuit for the X drive in FIG. 2 is not applied with corresponding to a partitioned gradation range.

FIG. 6 is a view for explaining a correction of a waveform of the signal line drive signal realized by the correction of the image signal by the output data conversion circuit for the X driver in FIG. 2.

FIG. 7 is a view showing contents of a look up table (LUT) held by the output data conversion circuit for the X driver in FIG. 2.

### DETAILED DESCRIPTION

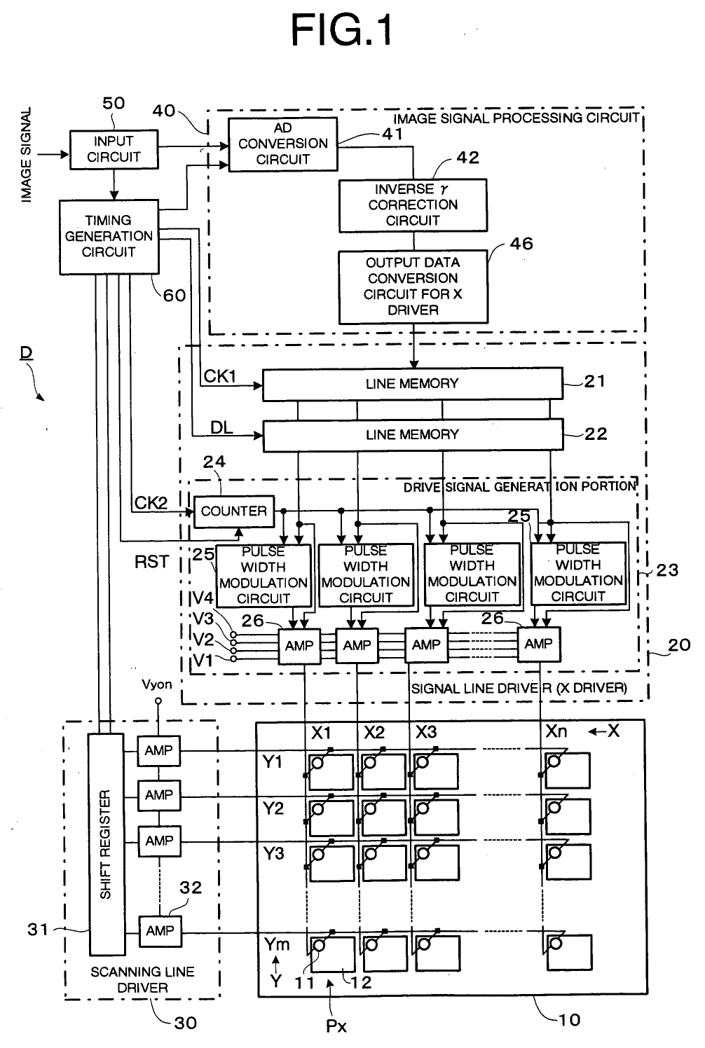

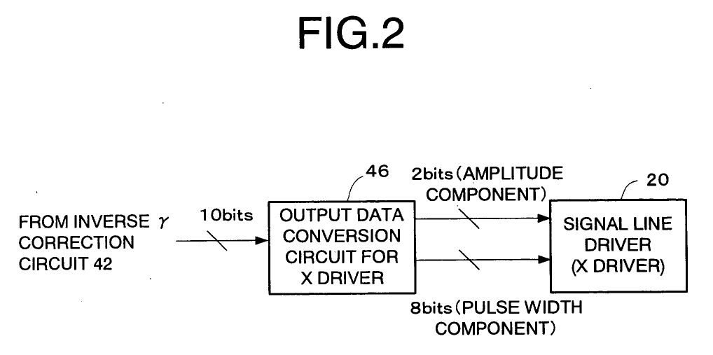

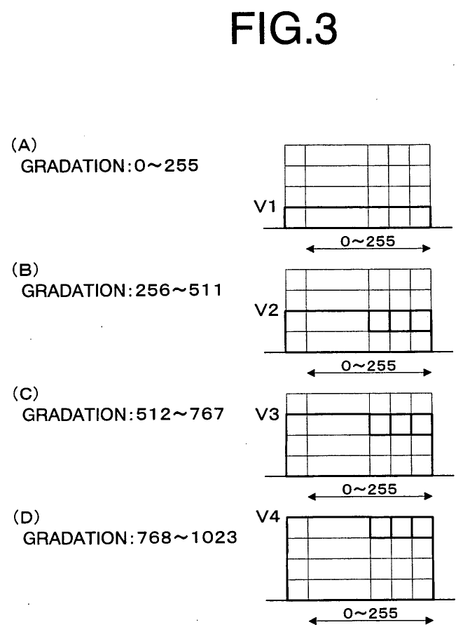

Hereinafter, a best mode for practicing the present invention is described based on the drawings. FIG. 1 is a view functionally showing a display device D according to one embodiment of the present invention, FIG. 2 is a view for explaining a function of an output data conversion circuit for an X driver included in the display device, and FIG. 3 is a graph representing an example of a signal waveform of a signal line drive signal. As shown in FIG. 1, the display device D includes a display panel 10, a signal line driver 20 as an X driver, a scanning line driver 30 as a Y driver, an image signal processing circuit 40, and a timing generation circuit 60.

An image signal and a synchronous signal are inputted to an input circuit 50, and separately outputted to the image signal processing circuit 40 and the timing generation circuit 60 respectively. The image signal processing circuit 40 performs a correction and so on of the image signal inputted from the input circuit 50, and outputs the image signal to the signal line driver 20. The timing generation circuit 60 outputs an operation timing based on the synchronous signal inputted from the input circuit 50 to the scanning line driver 30, the image signal processing circuit 40, and the signal line driver 20.

The signal line driver 20 converts the image signal inputted from the image signal processing circuit 40 into a drive signal, and outputs the drive signal to the display panel 10. The scanning line driver 30 converts the operation timing inputted from the timing generation circuit 60 into a scanning line signal, and outputs the scanning line signal to the display panel 10. The display panel 10 displays an image based on the drive signal and the scanning line signal inputted from the signal line driver 20 and the scanning line driver 30.

On the display panel 10, scanning lines Y and signal lines X are disposed. The scanning lines Y (Y1 to Ym) of m (=720) pieces extend in a lateral (horizontal) direction. The signal lines X (X1 to Xn) of n (=1280×3) pieces extend in a longitudinal (vertical) direction while crossing these scanning lines Y1 to Ym. Display pixels Px of m×n (=approximately 2,760,000) pieces are disposed in vicinities of intersection positions of these scanning lines Y1 to Ym and the signal lines X1 to Xn.

The display pixel Px has an electron emission element 11 and a phosphor 12. The electron emission element 11 is driven by the corresponding scanning line Y and the signal line X to emit electrons. The phosphor 12 emits light by an electron beam emitted from the electron emitting element 11. This phosphor 12 emits a light with a display color of red (R), green (G), or blue (B). Namely, the display pixel Px corresponds to a display color of red (R), green (G), or blue (B).

The display pixels Px of red (R), green (G), and blue (B) are respectively disposed in the longitudinal direction. Here, the three display pixels Px of red (R), green (G), and blue (B) disposed adjacent in the horizontal direction can be considered as one color pixel on the block. A full color display becomes possible by controlling these display pixels Px of red (R), green (G), and blue (B).

The signal line driver 20, the scanning line driver 30, the image signal processing circuit 40, the input circuit 50, and the timing generation circuit 60 are used as drive circuits of the display panel 10, and they are disposed around the display panel 10. The signal line driver 20 is connected to the signal lines X1 to Xn, and the scanning line driver 30 is connected to the scanning lines Y1 to Ym.

The input circuit 50 inputs an analog RGB image signal and the synchronous signal supplied from an external signal source, supplies the image signal processing circuit 40 with the image signal, and supplies the timing generation circuit 60 with the synchronous signal.

The image signal processing circuit 40 performs a signal processing for the image signal from the input circuit 50.

The timing generation circuit 60 controls the operation timings of the signal line driver 20, the scanning line driver 30, and the image signal processing circuit 40 based on the synchronous signal. By this control, the scanning line driver 30 sequentially drives the scanning lines Y1 to Ym by using the scanning signal, and the signal line driver 20 drives the signal lines X1 to Xn by the signal line drive signal in a voltage pulse method while the respective scanning lines Y1 to Ym are driven by the scanning line driver 30.

Here, the image signal processing circuit 40 has an AD conversion circuit 41, an inverse γ correction circuit 42, and an output data conversion circuit for an X driver 46.

The AD conversion circuit 41 converts the analog RGB image signal supplied from the input circuit 50 in synchronize with a horizontal synchronous signal into a digital format. In the AD conversion circuit 41, the analog RGB image signal is converted into a 10 bits gradation data capable of displaying, for example, 1024 gradations, for the respective display pixels Px.

The inverse γ correction circuit 42 performs an inverse γ correction while referring to a look up table for the inverse γ correction as a data conversion memory having a 2.2 power characteristic which is the same as the γ characteristic of a cathode-ray tube.

The later-described output data conversion circuit for the X driver 46 converts a signal containing information representing a gradation outputted from the inverse γ correction circuit 42 into a value being adapted for a voltage pulse method of the signal line drive signal. The output data conversion circuit for the X driver 46 stores the 10 bits conversion data of 1024 pieces allocated to every gradation value of the gradation data outputted from the inverse γ correction circuit 42. As shown in FIG. 2, upper two bits and lower eight bits of the gradation data after conversion respectively correspond to a pulse amplitude (element voltages V1 to V4) and a pulse width (time length of 0 to 256) of the signal line drive signal. The description of the signal line drive signal will be explained later with FIG. 3.

The signal line driver 20 includes line memories 21 and 22, and a drive signal generation portion 23.

The line memory 21 makes a sampling of the image signals within one horizontal line while synchronizing with a clock CK1 supplied from the timing generation circuit 60 during respective horizontal scanning period, and outputs these image signals, namely the gradation data of n pieces in parallel.

The line memory 22 latches the gradation data in response to a latch pulse DL supplied from the timing generation circuit 60 in a state in which every gradation data is outputted from the line memory 21, and holds the gradation data during the following one horizontal scanning period when the line memory 21 makes the sampling operation again.

The drive signal generation portion 23 generates the voltage pulses of n pieces having the pulse amplitudes and the pulse widths respectively corresponding to the gradation data outputted in parallel from the line memory 22 as the signal line drive signals, to supply to the signal lines X1 to Xn. The drive signal generation portion 23 includes a counter 24, pulse width modulation circuits 25 of n pieces, and output buffers 26 of n pieces.

The counter 24 has a 10-bit configuration, and it is initialized in response to a reset signal RST supplied from the timing generation circuit 60 in accordance with a start of the respective horizontal scanning periods. The counter 24 is then counted up by a clock CK2, supplied from the timing generation circuit 60 subsequently to the reset signal RST. After that, the counter 24 outputs a 10 bits count data representing an effective image period within the respective horizontal scanning periods by a time length of 1024 steps.

The respective pulse width modulation circuits 25 are composed of, for example, comparators, and compares a corresponding gradation data supplied from the line memory 22 with the count data supplied from the counter 24, to output the voltage pulse having the same pulse width in a period until the count data reaches the gradation data.

The respective output buffers 26 select and output positive element voltages V1, V2, V3, and V4 that are externally supplied, based on the upper two bits of the gradation data supplied to the corresponding pulse width modulation circuits 25. Consequently, the voltage pulse from the pulse width modulation circuit 25 is amplified to the same pulse amplitude as any one of these element voltages V1, V2, V3, and V4. At this time, a selected element voltage is outputted from the output buffer 26 during the same period as the pulse width of the pulse voltage from the pulse width modulation circuit 25. Namely, the output buffer 26 outputs the signal line drive signal having the pulse amplitude and the pulse width depending on the gradation value of the gradation data.

As shown in FIG. 2 and FIG. 3, the signal line drive signal is partitioned into four regions from (A) to (D) in accordance with the strength of the image signal, and has different amplitude values V1 to V4 by every region (partitioned gradation range). These regions (A) to (D) respectively correspond to the gradation values before conversion of 0 to 255, 256 to 511, 512 to 767, and 768 to 1023, and the upper two bits of the gradation data after conversion of “00”, “01”, ”10”, and “11”. The amplitude values V1 to V4 of the drive signal are enlarged step by step in the respective regions, and further, the pulse widths are made to be variable with corresponding to the values of the image signals in the respective regions (segmented gradation range), and thereby enabling a fine-grained gradation expression.

As shown in the region (A) of FIG. 3, when the gradation value is 0 to 255, the signal line drive signal has a pulse with the pulse amplitude of the element voltage V1 and the pulse width being the time length of 0 to 256.

As shown in the region (B) of FIG. 3, when the gradation value is 256 to 511, the signal line drive signal has a combination of a pulse with the pulse amplitude of the element voltage V2 and the pulse width being the time length of 0 to 255, and a pulse with the pulse amplitude of the element voltage V1 and the pulse width being the time length of the rest (to 255).

As shown in the region (C) of FIG. 3, when the gradation value is 513 to 768, the signal line drive signal has a combination of a pulse with the pulse amplitude of the element voltage V3 and the pulse width being the time length of 0 to 255, and a pulse with the pulse amplitude of the element voltage V2 and the pulse width being the time length of the rest (to 255).

As shown in the region (D) of FIG. 3, when the gradation value is 769 to 1024, the signal line drive signal has a combination of a pulse with the pulse amplitude of the element voltage V4 and the pulse width being the time length of 0 to 255, and a pulse with the pulse amplitude of the element voltage V3 and the pulse width being the time length of the rest (to 255).

The scanning line driver 30 includes a shift register 31 and an output buffer 32.

The shift register 31 shifts a vertical synchronization signal by every one horizontal scanning period to output from one of output terminals of m pieces. The output buffer 32 responds to pulses from the output terminals of m pieces of the shift register 31 respectively, to output scanning signals to the scanning lines Y1 to Ym.

The scanning signals outputted from the output buffer 32 are negative voltage Vyon supplied from a scanning voltage terminal, and they are outputted only for one horizontal scanning period.

At the respective electron emission elements 11, a discharge may occur when the element voltage Vf between electrodes composed of the signal line X and the scanning line Y exceeds a threshold, and the electron beam emitted by this excites the phosphor 12. Brightness of the respective display pixels Px is controlled by a drive current Ie flowing in the electron emission element 11 depending on the pulse width and the pulse amplitude of the signal line drive signal.

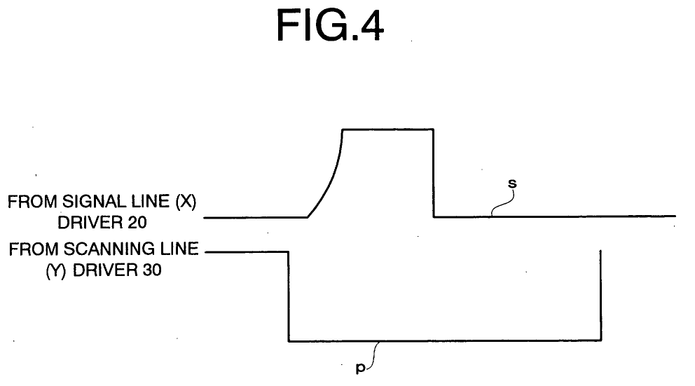

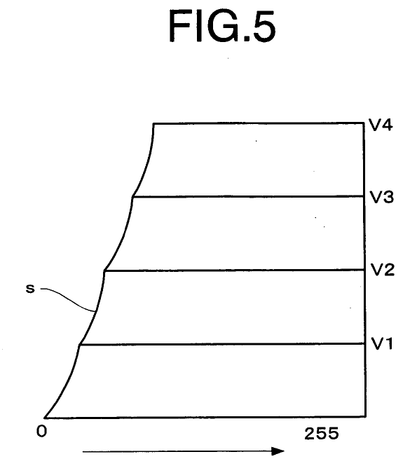

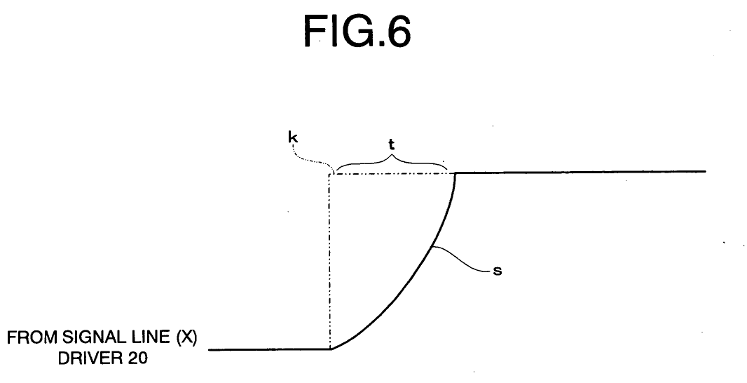

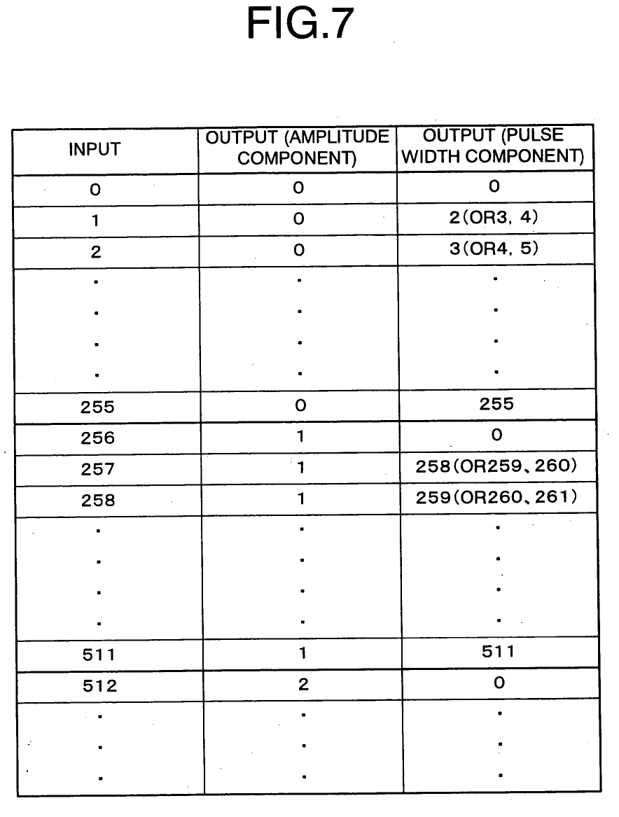

Next, a function realized by the output data conversion circuit for the X driver 46 included in the display device D of the present embodiment is described based on FIG. 4 to FIG. 7 in addition to FIG. 1 to FIG. 3. Here, FIG. 4 is a waveform chart showing a signal line drive signal s (and a scanning signal p) generated based on an image signal which is not applied a correction by the output data conversion circuit for the X driver 46 in FIG. 2, and FIG. 5 is a waveform chart showing the signal line drive signal s in FIG. 4 to correspond to the partitioned gradation range. Besides, FIG. 6 is a view for explaining a correction of a waveform of the signal line drive signal realized by the correction of the image signal by the output data conversion circuit for the X driver 46, and FIG. 7 is a view showing contents of a look up table held by the output data conversion circuit for the X driver 46.

As shown in FIG. 4 to FIG. 6, it turns out that a linear brightness characteristic cannot be obtained in a relation between the signal line drive signal and a light-emission brightness of the display pixel Px of the display panel 10, and an image cannot be truly reproduced, even if the image signal is corrected by the inverse γ correction circuit 42. Namely, at a rising time of a drive pulse of the signal line drive signal s, a time t is necessary until a waveform s rises completely due to an influenced of an inductance component of the wiring of the display panel 10. In particular, in the display panel of a large screen, the wiring becomes long, and therefore, the influence thereof is large. Consequently, when an output value is small, there is a case when the drive pulse does not rise completely, and the brightness becomes lower than a logical value. Besides, a phosphor becomes saturated as the pulse width of the signal line drive signal s becomes large, and also in this case, the deterioration of the brightness is provoked.

Consequently, the display device D of the present embodiment includes the output data conversion circuit for the X driver 46 having the look up table shown in FIG. 7 to which an improvement is made to the look up table for a normal signal line driver (X driver) output conversion.

Namely, the output data conversion circuit for the X driver 46 converts (corrects) an image signal containing information representing a gradation inputted from the inverse γ correction circuit 42 into a signal which corresponds to the amplitude component and the pulse width corresponding to the amplitude of the signal line drive signal and which has a corrected pulse width component (so as to correct a nonlinearity of the corresponding waveform s shown in FIG. 6 during the rising period t). In detail, the output data conversion circuit for the X driver 46 corrects the nonlinearity of the pulse width of the signal line drive signal s corresponding to the brightness of the display pixel Px of the display panel 10 shown in FIG. 6 so as to be shown by a virtual line k (to stand up orthogonally) while referring to the contents of the look up table shown in FIG. 7. Of course, the corrected amplitude component of the signal line drive signal corresponds to the partitioned gradation range partitioning the gradation range of the image signal, and the pulse width component corresponds to the sectionalized gradation range further sectionalizing the partitioned gradation range (refer to FIG. 3).

Further, in the look up table referred to by the output data conversion circuit for the X driver 46, a characteristic is added to an output of the pulse width component of a portion corresponding to the rising period t shown in FIG. 6. Namely, as shown in FIG. 7, the output data conversion circuit for the X driver 46 stores outputs corresponding to the pulse width component of 2 (or 3, or 4), 3 (or 4, or 5), and so on, which are respectively larger than 1 and 2, for inputs such as 1, 2, and so on, corresponding to the rising period t, as the LUT. Besides, similarly, for the inputs of 257 and 258 corresponding to the rising period t, 258 (or 259, or 260), 259 (or 260, or 261), and so on, which are larger than 257 and 258 are stored as the outputs corresponding to the pulse width component. Namely, it is constituted so that the input corresponding to the rising period t is biased, and the output corresponding to the pulse width component having a larger value than the corresponding input can be obtained.

Namely, the output data conversion circuit for the X driver 46 included in the display device D precisely increases a light-emission brightness of the display pixel Px of the display panel 10 in accordance with the increase of the signal line drive signal, and thereby enabling to obtain a linear brightness characteristic. Consequently, according to the display device D of the present embodiment, it is possible to realize an effective gradation correction to obtain a good brightness characteristic without adding a new correction circuit and so on to obtain the linear brightness characteristic (without increasing a manufacturing cost and so on).

Besides, in the display device D according to the present embodiment, the LUT for the output conversion of the X driver is applied to the gradation correction to obtain the above-stated linear brightness characteristic, and therefore, a common look up table for an inverse γ correction can be used for plural display panels respectively having different brightness characteristics. Further, when a γ characteristic is changed by various image modes, the common look up table for the inverse γ correction can be used for the plural display panels having the different brightness characteristics.

Hereinabove, the present invention is concretely described with the embodiment, but the present invention is not limited to the above-described embodiment, and it may be modified in other specific forms without departing from the spirit or essential characteristics thereof.

What is claimed is:

1. A display device, comprising:
a display unit in which pixels driven by a drive signal having plural levels of amplitudes and pulse widths are disposed;
an input unit inputting an image signal containing information representing gradations corresponding to a brightness of the pixel;
an output data converter for a signal line driver converting the image signal inputted to said input unit into a signal having an amplitude component corresponding to the amplitude and a pulse width component corresponding to the pulse width based on the gradations; and
a drive signal generator generating the drive signal from the image signal converted by said output data converter for the signal line driver.

2. A display device according to claim 1,
wherein said output data converter for the signal line driver corrects a nonlinearity of the pulse width of the drive signal.

3. A display device according to claim 1,
wherein said output data converter for the signal line driver converts the image signal inputted to said input unit into the signal having the amplitude component corresponding to the amplitude and a pulse width component corresponding to the pulse width being corrected so as to correct a rising of the corresponding pulse width.

4. A display device according to claim 2,
wherein the amplitude component corresponds to a partitioned gradation range partitioning a gradation range of the image signal, and the pulse width component corresponds to a segmented gradation range further segmentalizing the partitioned gradation range.

5. A display device according to claim 2,
further comprising a table in which the image signals before and after conversion are represented correspondingly, and
wherein said output data converter for the signal line driver refers to said table to perform conversion of the image signal and correction of the pulse width component.

6. A display device according to claim 5,
wherein said table is constituted so as to output a larger value than a value of an inputted image signal, as an output corresponding to the pulse width component of said output data converter for the signal line driver, as for the inputted image signal corresponding to a rising period of the pulse width.

7. A display device according to claim 2,
wherein the drive signal contains a drive current, and a brightness of said display unit is controlled by the drive current.

8. A display device according to claim 2,
further comprising an inverse γ correction unit performing an inverse γ correction of the inputted image signal.

9. A display device according to claim 8,
wherein said inverse γ correction unit includes a table for the inverse γ correction.

10. A display method, which displays an image on a display unit in which pixels driven by a drive signal having plural levels of amplitudes and pulse widths are disposed, comprising:
inputting an image signal containing information representing gradations corresponding to a brightness of the pixel;
converting the inputted image signal into a signal having an amplitude component corresponding to the amplitude and a pulse width component corresponding to the pulse width based on the gradations; and
generating the drive signal from the converted image signal.

11. A display method according to claim 10,
Wherein said converting step performs a correction of a nonlinearity of the pulse width of the drive signal.

12. A display method according to claim 10,
Wherein said converting step performs a conversion of the inputted image signal into a signal having the amplitude component corresponding to the amplitude and the pulse width component corresponding to the pulse width being corrected so as to correct a rising of the corresponding pulse width.

13. A display method according to claim 11,
wherein the amplitude component corresponds to a partitioned gradation range partitioning a gradation range of the image signal, and the pulse width component corresponds to a segmented gradation range further segmentalizing the partitioned gradation range.

14. A display method according to claim 11,
wherein a table correspondingly representing the image signals before and after conversion is referenced to perform a conversion of the image signal and a correction of the pulse width component in said converting step.

15. A display method according to claim 14,
wherein the table is constituted so as to output a larger value than a value of an inputted image signal as an output corresponding to the pulse width component of the output data converter for the signal line driver, as for the inputted image signal corresponding to a rising period of the pulse width.

16. A display method according to claim 11,
further comprising performing an inverse γ correction of the inputted image signal.
